(19) United States
(12) Patent Application Publication
(10) Pub. No.: US 2014/0188717 A1
(43) Pub. Date: Jul. 3, 2014

(54) Method and Apparatus for Payment of Invoices

(71) Applicant: David Gillman, Dallas, TX (US)

(72) Inventor: David Gillman, Dallas, TX (US)

(21) Appl. No.: 13/826,455

(22) Filed: Mar. 14, 2013

Related U.S. Application Data
(60) Provisional application No. 61/748,413, filed on Jan. 2, 2013.

(51) Int. Cl. G06Q 20/10

(52) U.S. Cl. CPC G06Q 20/102
USPC 705/40

(57) ABSTRACT

A payment server, method, and computer readable medium for making a payment from a payer to a payee are provided. The method includes sending from a payment system to a payee an electronic remittance advice (ERA). The ERA includes a payment portion, login information relating to a payment, and a description of the payment. The method further includes sending from the payment system to the payee a payment detail relating to the payment, where the payment detail is sent in response to receiving at the payment system the login information from the payee.

### CROSS-REFERENCE TO RELATED APPLICATION(S) AND CLAIM OF PRIORITY

The present application is related to U.S. Provisional Patent No. 61/748,413, filed Jan. 2, 2013, entitled “METHOD AND APPARATUS FOR PAYMENT OF INVOICES”. Provisional Patent No. 61/748,413 is assigned to the assignee of the present application and is hereby incorporated by reference into the present application as if fully set forth herein. The present application hereby claims priority under 35 U.S.C. §119(e) to U.S. Provisional Patent No. 61/748,413.

### TECHNICAL FIELD OF THE INVENTION

The present application relates generally to payment systems and, more specifically, to a method and apparatus for payment of invoices.

### BACKGROUND OF THE INVENTION

A commercial entity may have a large number of vendors from which it receives invoices and to which it makes payments. Examples of such an entity include an insurer making payments to healthcare providers; a retailer making payments to suppliers; an advertiser making payments to media outlets; and a hospital making payments for laundry, maintenance, supplies, etc.

Such payments may be made by check or by an electronic transfer, such as a wire transfer or Automatic Clearing House (ACH) transfer. Such payments typically include payment details, to inform the payee of the invoice and/or items being paid.

### SUMMARY OF THE INVENTION

Various embodiments include a payment server, method, and computer readable medium. A method for making a payment from a payer to a payee using a payment system is provided. The method includes sending from a payment system to a payee an electronic remittance advice (ERA). The ERA includes a payment portion, login information relating to a payment, and a description of the payment. The method further includes sending from the payment system to the payee a payment detail relating to the payment, where the payment detail is sent in response to receiving at the payment system the login information from the payee.

A payment server for making a payment from a payer to a payee is provided. The payment server is adapted to receive a payment file from a payer. The payment server is further adapted to send to a payee an ERA. The ERA is based on the payment file. The ERA includes a payment portion, login information relating to a payment, and a description of the payment. The payment server is still further adapted to send to the payee a payment detail relating to the payment, where the payment detail is sent in response to receiving the login information from the payee.

A non-transitory computer-readable storage medium is provided, encoded with computer-executable instructions that, when executed, cause a data processing system to send to a payee an ERA. The ERA includes a payment portion, login information relating to a payment, and a description of the payment. The instructions further cause the data processing system to send to the payee a payment detail relating to the payment, in response to receiving the login information from the payee.

Other technical features may be readily apparent to one skilled in the art from the following figures, descriptions and claims.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram of a system for making payments by check;

FIG. 2 illustrates a block diagram of a system for making payments by payment portal;

FIG. 3 illustrates a procedure for receiving a payment via a payment portal;

FIG. 4 is a block diagram of a payment system according to an exemplary embodiment of the disclosure;

FIG. 5 is a block diagram of an electronic remittance advice form according to an exemplary embodiment of the disclosure;

FIG. 6 is a block diagram of a payment detail form according to an exemplary embodiment of the disclosure; and

FIG. 7 illustrates a procedure for use of a payment system according to an exemplary embodiment of the disclosure.

### DETAILED DESCRIPTION OF THE INVENTION

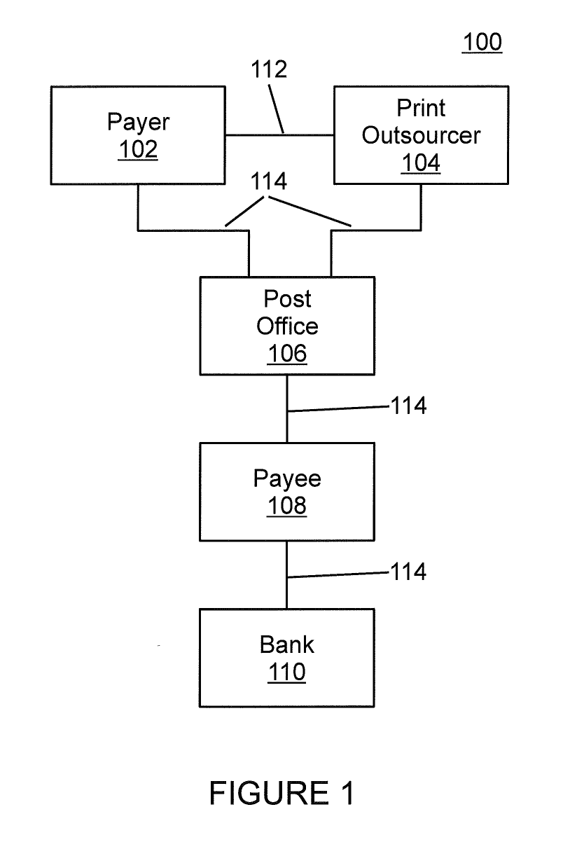

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged method and apparatus for payment of invoices.

FIG. 1 illustrates a block diagram 100 of a system for making payments by check. A payer 102 may contract with a print outsourcer 104 (or fulfillment vendor) to print checks for use in paying suppliers, vendors, or other payees that have presented invoices to the payer 102. The payer 102 provides payment data 112 to the print outsourcer 104 relating to the desired payments.

The print outsourcer 104 may print checks 114 and send the printed checks 114 to the payer 102. In one alternative, the print outsourcer 104 may print the checks 114 and send each check 114 to a payee 108 via a post office or other physical delivery service 106 (such as courier, FedEx, UPS, etc.). In still another alternative, the payer 102 may print the checks 114. Whether printed by the print outsourcer 104 or by the payer 102, the payer 102 may then send each check 114 to the payee 108 via the delivery service 106. One or more pages of remittance advice may accompany each check. Upon receiving the check 114, the payee 108 will deposit the check 114 with a bank 110 to complete the payment transaction.

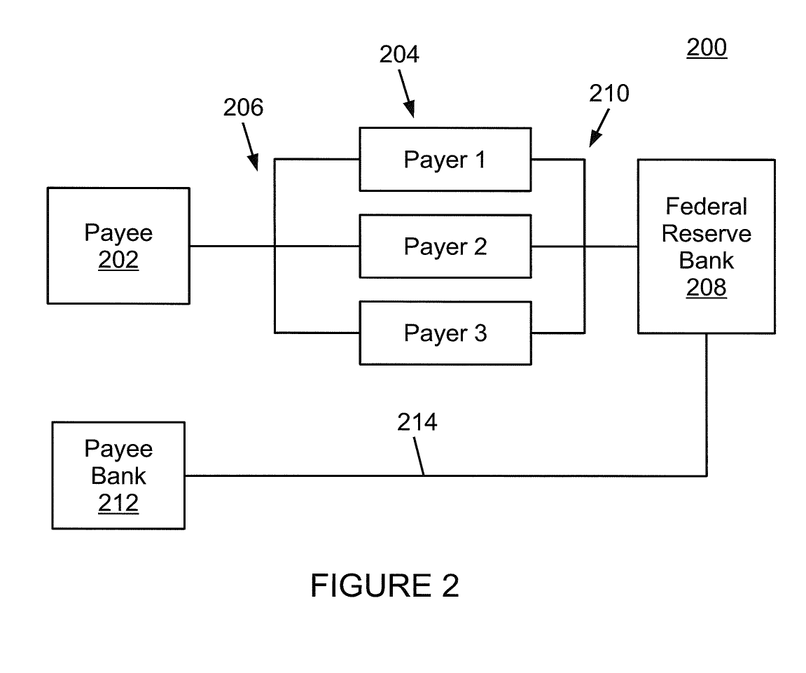

FIG. 2 illustrates a block diagram of a system 200 for making payments by payment portal. A payee 202 desiring to receive payments from one or more payers may connect via a communication link 206 (such as the Internet) one or more payment portals 204 provided by the desired payer. Typically, each payer provides an individual payment portal for use by its payees. The payee 202 registers at each desired payment portal and typically establishes a login ID and associated password.

Once the payee 202 has registered at the payment portal 204, the payee 202 may log into the payment portal 204 to determine whether the associated payer has a payment ready for the payee 202. If one or more payments are available, the payee 202 may download remittance advice and payment information associated with the payment(s).

In one alternative, the payment information relates to a stored value debit card (or virtual credit card), which the payee 202 uses in a conventional credit card transaction to deposit money in a payee bank 212. In another alternative, the payment information relates to a buyer-initiated payment (BIP) in which the payer initiates a credit card transaction against the payer's own credit card and the payment is pushed to the payee bank 212. In still another alternative, the payment information relates to an electronic funds transfer (EFT), in which the payment portal 204 sends information via a communication link 210 to a Federal Reserve Bank 208 to cause funds to be transferred from the payer's bank to the payee's bank 212.

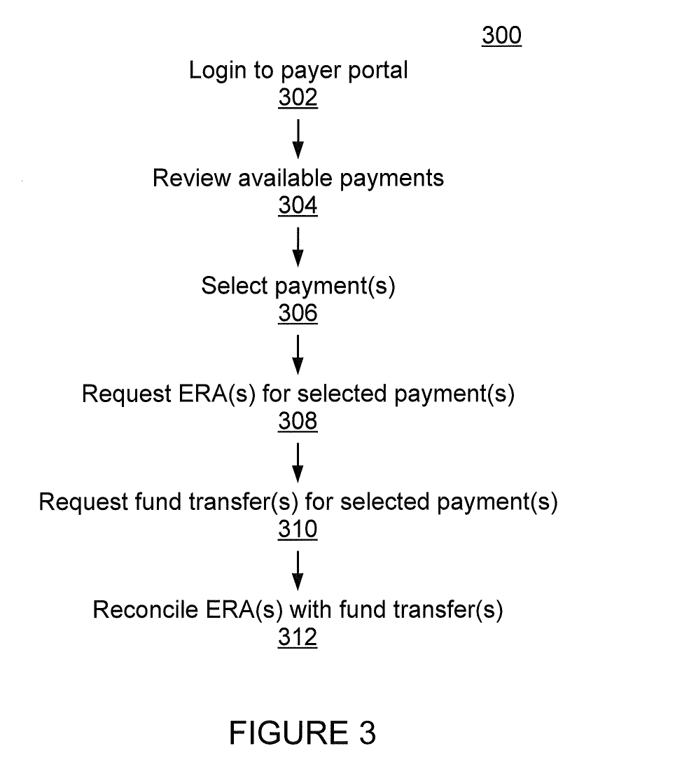

FIG. 3 illustrates a procedure 300 for receiving a payment via a payment portal. In step 302, the payee 202 logs into the payment portal 204 and, in step 304, reviews available payments, if any. In step 306, the payee selects one or more available payments and, in step 308, requests an electronic remittance advice (ERA) for the selected payments. In step 310, the payee 202 requests that the payment portal 204 perform an EFT for the selected payments. In response, the payment portal 204 transfers the requested payments electronically to the payee bank 212 via the Federal Reserve Bank 208. In step 312, the payee 202 may reconcile the EFTs received at the payee bank 212 in step 310 with the ERAs received from the payment portal 204 in step 308.

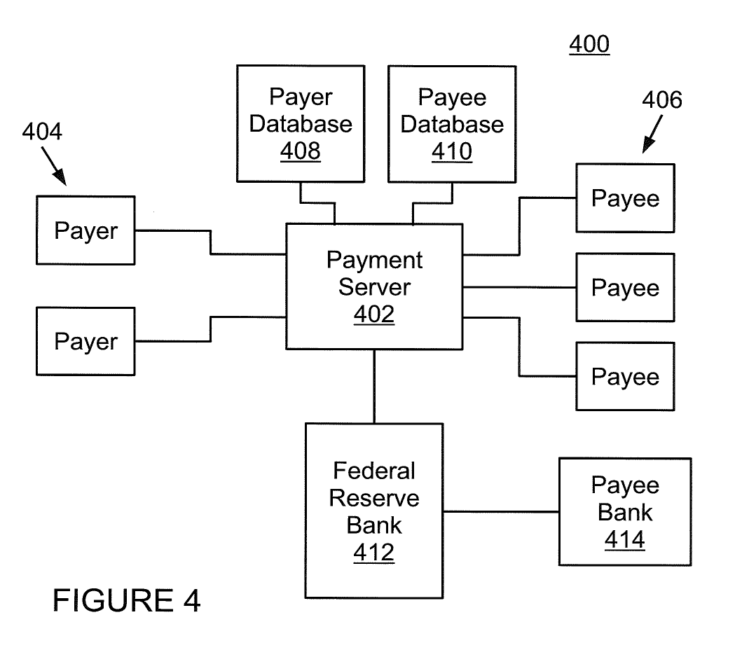

FIG. 4 is a block diagram of a payment system according to an exemplary embodiment of the disclosure. One or more payers 404 communicate with a payment server 402. The payment server 402 may be provided by a third party, independent service organization (ISO) or by one or more of the payers 404. The payment server 402 makes payments to payees 406 on behalf of the payers 404.

The payment server 402 receives from each payer 404 information relating to payee identity, which may include payer name, address, federal or state taxpayer identification (TID), and/or Office of Foreign Asset Control (OFAC) Know Your Customer (KYC) information. The payment server 402 may also receive other payer information, such as default payee contact method, payment details, document style, data file formats, and/or other information relating to the requirements of the payer 404 for making payments to one or more of the payees 406. The payment server 402 stores such payer information in a payer database 408. The payment server 402 stores in a payee database 410 information received from the payers 404 and from the payees 406 relating to each payee 406. Examples of such payee information include an identity and contact information for the payee 406, as well as methods of contact, payment notification, and payment that are preferred by the payee 406.

A payer 404 sends a payment file to the payment server 402, which includes information identifying one or more payees 406 and one or more payments to be made to each of those payees. The payment file may be sent from the payer 404 to the payment server 402 via secure file transfer protocol (FTP), web browser upload, or other mutually agreed upon electronic transfer methodology. The method for delivery of the payment file may be negotiated between the payer and the payment server 402.

The payment server 402 processes the payment file to generate a payment transaction for each payee identified in the payment file. More than one payment transaction may be for an individual payee, or all payments due to a payee may be combined into a single payment transaction.

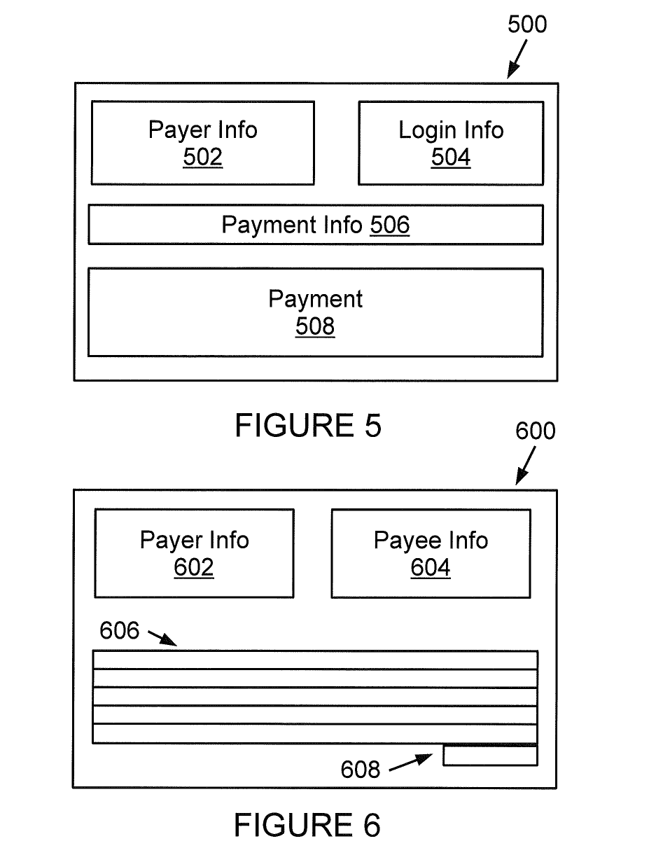

As will be described in greater detail with reference to FIGS. 5-7, for each payment transaction, the payment server 402 generates a unique combination of payment identifier (PID), authorization code (AC), and account number. The account number may relate to a virtual credit card, BIP, or EFT. Where the payment is made through an EFT/ACH transaction, the payment server 402 sends details of the transaction to a Federal Reserve Bank 412, to effect transfer of the payment to a payee bank 414. The payment server 402 also creates from the payment file, for each payment transaction, a payment detail (PD) for the transaction.

The payment server 402 comprises a data processing system providing server functionality to client data processing systems of the payers 404 and client data processing systems of the payees 406. Typically, the data processing system of the payment system communicates as a client device with a server system of the Federal Reserve Bank 412.

The payment server 402 includes data processing hardware such as a processor and storage that can include volatile memory, non-volatile memory, optical storage, magnetic storage, or other computer-readable storage media as known to those in the art. The payment server 402 can be implemented using one or more physical systems, and may include multiple processors.

The payment server 402 may include one or more communication interface circuits adapted to communicate electronically via the Internet or other networked communication link to one or more of the payers 404, the payees 406, and the Federal Reserve Bank 412. The payment server 402 may further include one or more telephone communication interface circuits adapted to couple to a wired or wireless telephone network to send fax messages to the payees 406. The payment server 402 may also include one or more printers adapted to print ERAs and PDs for physical delivery to payees 406.

While this disclosure includes a description in the context of a fully functional system, those skilled in the art will appreciate that at least portions of the mechanism of the present disclosure are capable of being distributed in the form of a instructions contained within a non-transitory machine-usable, computer-usable, or computer-readable medium in any of a variety of forms, and that the present disclosure applies equally regardless of the particular type of instruction bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

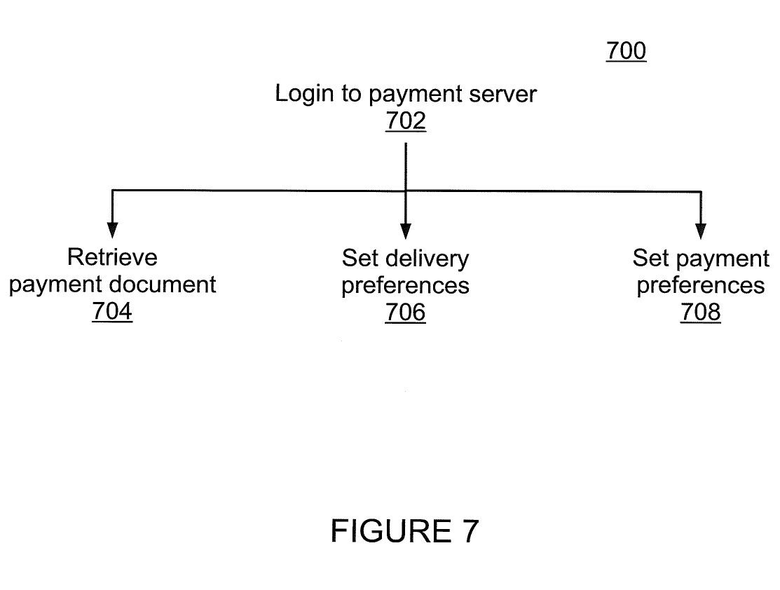

FIG. 5 is a block diagram of an electronic remittance advice (ERA) form 500 according to an exemplary embodiment of the disclosure. Based upon information in the payment file, the payer database 408, and the payee database 410, the payment server 402 generates the ERA form 500 to send to a payee 406 as notice of an available payment. The ERA form 500 includes a payer information portion 502, which includes information identifying the payer 404 making the payment. The ERA form 500 also includes a login information portion 504 that comprises a website link (or Uniform Resource Locator [URL]) to access the payment server 402, as well as the PID and AC created by the payment server 402 for this payment transaction. As will be described in greater detail with reference to FIG. 7, the PID and AC may be used by the payee 406 to log into the payment server 402 to receive additional information regarding the payment, including the PD for the transaction.

The ERA form 500 also includes a payment description portion 506 including information such as an amount of the payment, identification of invoice(s) from the payee 406 to the payer 402, and/or other information relating to the reason for this payment. The ERA form 500 further includes a payment portion 508, which may include the account number generated by the payment server 402. The format of the payment portion 508 is based upon preference information stored in the payee database 410 for the payee 406 receiving the payment, or upon default information stored in the payer database 408 for the payer 404 originating the payment. The payment portion 508 may be in the form of a virtual credit card account, expiration date, and Card Verification Code (CVC) security code. The payer 404 or payment server 402 pre-loads the virtual credit card with an amount equal to the amount of this payment transaction. The payee 406 may submit the virtual credit card information via a physical credit card terminal or Internet virtual merchant terminal, in order to receive the amount of the payment. In one alternative, the payment portion 508 may be in the form of a trace number or other information related to an EFT transaction from the payer 404 (or payment server 402) to the payee 406. The trace number associated with the EFT may be generated by combining the payer info and the PID or a check number from the payer's accounting system. In another alternative, where the ERA form 500 is mailed to the payee 406, the payment portion 508 may be in the form of a check, which the payee 406 may detach and deposit in its bank.

FIG. 6 is a block diagram of a payment detail (PD) form 600 according to an exemplary embodiment of the disclosure. For each payment transaction from a payer 404 to a payee 406, the payment server 402 generates an ERA form 500 and a PD form 600. Based upon payer 404 default or upon payee 406 preference, the PD form 600 may be sent to the payee 406 along with the ERA form 500, where the ERA form 500 is sent by facsimile (fax), secure email, mail, or other secure communication means.

The PD form 600 includes a payer information portion 602, which may be identical to the payer portion 502 of the ERA form 500, or may include more or less information than the payer portion 502. The PD form 600 also includes payee information 604 that confirms the identity of the payee 406 to which the payment is being made. The PD form 600 further includes a detail portion 606 whose format may be determined by document style preference information stored in the payer database 408 described with reference to FIG. 4. The detail portion 606 may include details relating to individual invoices that are settled with the present payment, line items from invoices settled by the payment, or any other payment details the payer 404 desires to include with a payment to the payees 406. The PD form 600 may also include a payment total portion 608, to cross-check against information in the ERA form 500.

FIG. 7 illustrates a procedure 700 for use of a payment system according to an exemplary embodiment of the disclosure. In step 702, using the login information 504 received with the ERA form 500, the payee 406 may access the payment server 402 via a communication link and log in using the PID and AC. Communication between the payee 406 and the payment server 402 may be via any suitable secure communication link, such as a secure Internet connection. The login information 504 permits the payee 406 to obtain access within the payment server 402 to the PD form 600 relating only to the ERA form 500, as well as to information in the payee database 410 relating only to the payee 406 to which this payment is being made. Once logged into the payment server 402 in step 702, the payee 406 may perform one or more further steps of the procedure 700 in any combination or order.

In step 704, the payee 406 may retrieve the PD form 600 relating to this payment. The PD form 600 may be electronically downloaded by the payee 406, or the payment server 402 may be requested to send the PD form 600 via secure email, mail, or some other secure delivery means.

In step 706, the payee 406 may indicate one or more preferences for future delivery of ERA forms 500 and/or PD forms 600 and cause those preferences to be stored in the payee database 610. Such delivery preferences may specify that ERA form 500 and PD form 600 are to be delivered together, or that only the ERA form 500 is to be delivered. The delivery preferences may specify a delivery method such as fax, secure email, US Post Office, FedEx, UPS, or other suitable delivery method.

In step 708, the payee 406 may indicate a preference for future transfer of payments from the payer 404 or payment server 402 and cause that preference to be stored in the payee database 610. The payment preference may specify a payment method such as virtual credit card, BIP, EFT/ACH, check, or other suitable payment method.

While the payment server 402 has been described as a unified system providing both notification and payment functions, it will be understood that the payment server 402 may be implemented in other embodiments as a plurality of cooperating subsystems, with any suitable distribution of functions. In one embodiment, a first subsystem may process payment files, maintain payer database 408 and/or payee database 410, and send ERA forms 500 and/or PD forms 600 to payees 406, while a second subsystem manages financial transfer of the payment via check, virtual credit card, BIP, EFT/ACH or other suitable means.

It may be advantageous to set forth definitions of certain words and phrases that have been used within this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

Although the present disclosure has been described with an exemplary embodiment, various changes and modifications may be suggested to one skilled in the art. It is intended that the present disclosure encompass such changes and modifications as fall within the scope of the appended claims.

1. A method for making a payment from a payer to a payee using a payment system, the method comprising:
sending from a payment system comprising data processing hardware to a payee an electronic remittance advice (ERA) describing a payment made using an account having an associated account number, the ERA comprising a payment portion, login information relating only to the payment, and a description of the payment;
generating a unique combination of a payment identifier, an authorization code, and the account number; and
sending from the payment system to the payee a payment detail relating to the payment, in response to receiving at the payment system the unique login information from the payee,
wherein the login information comprises the payment identifier and the authorization code from the generated unique combination.

2. The method of claim 1, wherein the ERA is sent to the payee via one of fax, secure email, and physical delivery service.

3. The method of claim 1, wherein the ERA is sent to the payee using a delivery method selected by the payee.

4. The method of claim 3, wherein the payment system stores information relating to the delivery method selected by the payee.

5. The method of claim 1, wherein sending the ERA to the payee further comprises sending the payment detail to the payee.

6. The method of claim 1, further comprising transferring funds to the payee using a payment method comprising one of a virtual credit card, an electronic fund transfer transaction, and a physical check, wherein the payment portion of the ERA comprises a corresponding one of information relating to the virtual credit card, trace information relating to the electronic fund transfer transaction, and the physical check.

7. The method of claim 6, wherein:
the payment method is selected by the payee; and
the payment system stores information relating to the payment method selected by the payee.

8. A payment server for making a payment from a payer to a payee, the payment server comprising data processing hardware and configured to:
receive a payment file from a payer;
send to a payee an electronic remittance advice (ERA), the ERA based on the payment file, wherein the ERA comprises a payment portion, login information relating to a payment, and a description of the payment; and
generate a unique combination of a payment identifier, an authorization code, and an account number associated with an account used for the payment;
send to the payee a payment detail relating to the payment, in response to receiving the login information from the payee,
wherein the login information comprises the payment identifier and the authorization code from the generated unique combination.

9. The payment server of claim 8, wherein the payment server is further configured to send the ERA to the payee via one of fax, secure email, and physical delivery service.

10. The payment server of claim 8, wherein the payment server is further configured to:
receive from the payee an indication of a preferred delivery method; and
send the ERA to the payee using the preferred delivery method.

11. The payment server of claim 10, wherein the payment server is further configured to store information relating to the preferred delivery method indicated by the payee.

12. The payment server of claim 8, wherein the payment server is further configured to transfer funds from the payer to the payee using a payment method comprising one of a virtual credit card, an electronic fund transfer transaction, and a physical check, wherein the payment portion of the ERA comprises a corresponding one of information relating to the virtual credit card, trace information relating to the electronic fund transfer transaction, and the physical check.

13. The payment server of claim 12, wherein the payment server is further configured to:
receive from the payee an indication of a preferred payment method; and
store information relating to the preferred payment method indicated by the payee.

14. A non-transitory computer-readable storage medium encoded with computer-executable instructions that, when executed, cause a data processing system to perform the steps of:
sending to a payee an electronic remittance advice (ERA) describing a payment made using an account having an associated account number, the ERA comprising a payment portion, login information relating only to the payment, and a description of the payment;
generating a unique combination of a payment identifier, an authorization code, and the account number; and
sending to the payee a payment detail relating to the payment, in response to receiving the login information from the payee,
wherein the login information comprises the payment identifier and the authorization code from the generated unique combination.

15. The computer-readable storage medium of claim 14, wherein the ERA is sent to the payee via one of fax, secure email, and physical delivery service.

16. The computer-readable storage medium of claim 14, further encoded with computer-executable instructions that, when executed, cause a data processing system to perform the steps of:
receiving from the payee an indication of a preferred delivery method; and
sending the ERA to the payee using the preferred delivery method.

17. The computer-readable storage medium of claim 16, further encoded with computer-executable instructions that, when executed, cause a data processing system to perform the steps of:
storing information relating to the preferred delivery method indicated by the payee.

18. The computer-readable storage medium of claim 14, wherein the step of sending the ERA to the payee further comprises sending the payment detail to the payee.

19. The computer-readable storage medium of claim 16, further encoded with computer-executable instructions that, when executed, cause a data processing system to perform the steps of:
transferring funds to the payee using a payment method comprising one of a virtual credit card, an electronic fund transfer transaction, and a physical check, wherein the payment portion of the ERA comprises a corresponding one of information relating to the virtual credit card, trace information relating to the electronic fund transfer transaction, and the physical check.

20. The computer-readable storage medium of claim 16, further encoded with computer-executable instructions that, when executed, cause a data processing system to perform the steps of:
receiving from the payee an indication of a preferred payment method; and
storing information relating to the preferred payment method indicated by the payee.
